(19) United States
(12) Patent Application Publication
(10) Pub. No.: US 2010/0284334 A1
(43) Pub. Date: Nov. 11, 2010

(54) ASYNCHRONOUS MULTI-CHANNEL ADAPTATION METHOD FOR WIRELESS AD-HOC NETWORK

(75) Inventors: Chang Sub Shin, Daejeon (KR); Wun Cheol Jeong, Daejeon (KR); An Seok Lee, Gyeongbuk (KR); Seong Soon Joo, Daejeon (KR); Jong Suk Chae, Daejeon (KR); Myung Jong Lee, New York, NY (US); Gahng Seop Ahn, New York, NY (US); Jun Sun Ryu, New York, NY (US)

Correspondence Address: AMPACC Law Group, 3500 188th Street S.W., Suite 103, Lynnwood, WA, 98037, US

(73) Assignees: Electronics and Telecommunications Research Institute, Daejeon (KR); City University of New York, New York, NY (US)

(21) Appl. No.: 12/776,358

(22) Filed: May 7, 2010

(30) Foreign Application Priority Data
May 8, 2009 (KR) 10-2009-0040133
Apr. 21, 2010 (KR) 10-2010-0036812

(51) Int. Cl. H04W 40/00

(52) U.S. Cl. 370/328

(57) ABSTRACT

There is provided an asynchronous multi-channel adaptation method. An asynchronous multi-channel adaptation method according to an aspect of the invention may include: a channel scanning operation in which a new node, participating in a wireless ad-hoc network, scans channels and selects a receiving channel thereof; and a receiving channel information transmission operation in which the new node transmits information on the selected receiving channel thereof to a neighboring node.

### CROSS-REFERENCE TO RELATED APPLICATIONS

This application claims the priorities of Korean Patent Application Nos. 10-2009-0040133 filed on May 8, 2009 and 10-2010-0036812 filed on Apr. 21, 2010, in the Korean Intellectual Property Office, the disclosures of which are incorporated herein by reference.

### BACKGROUND OF THE INVENTION

1. Field of the Invention

The present invention relates to an asynchronous multi-channel adaptation method for a wireless ad-hoc network, and more particularly, to a technique for improving network scalability and reliability in data transmission in a wireless ad-hoc network by causing a new node, participating in the wireless ad-hoc network, to undergo a channel scanning process, a receiving channel information transmission process and a channel switching process to thereby use multiple channels in order that nodes, forming the wireless ad-hoc network, receive data from neighboring nodes through receiving channels thereof and transmit data through a receiving channel of a destination node.

2. Description of the Related Art

In general, wireless data transmission in a wireless ad-hoc network is weak in terms of reliability and scalability due to frequency interference between nodes and unstable RF channel characteristics.

Among techniques proposed to solve these problems, a channel hopping method and a channel adaptation method are provided as methods using multiple channels.

According to a channel hopping method, all of the nodes, forming a wireless ad-hoc network, transmit and receive sync signals to thereby form a synchronized configuration, in which channel hopping is periodically performed. However, since synchronization needs to be established across the entire network, an overhead may be thereby caused and stability may be reduced.

Furthermore, according to a channel adaption method, while data communication is performed using a given channel, and the channel quality of the channel being used is reduced, the data communications will continue by switching the old channel to a new channel. This channel adaptation method may be divided into synchronous and asynchronous channel adaptation methods. In the same manner as the above-described channel hopping method, the synchronous channel adaption method causes problems associated with synchronization.

Therefore, there has been a need for techniques in order to assign and maintain multiple channels by using a simple asynchronous adaptation method incurring a low control overhead.

### SUMMARY OF THE INVENTION

An aspect of the present invention provides an asynchronous multi-channel adaptation method for a wireless ad-hoc network that can improve network scalability and reliability in data transmission in a wireless ad-hoc network by causing a new node, participating in the wireless ad-hoc network, to undergo a channel scanning process, a receiving channel information transmission process and a channel switching process to thereby use multiple channels in order that nodes, forming the wireless ad-hoc network, receive data from neighboring nodes through receiving channels thereof and transmit data through a receiving channel of a destination node.

According to an aspect of the present invention, there is provided an asynchronous multi-channel adaptation method including: a channel scanning operation in which a new node, participating in a wireless ad-hoc network, scans channels and selects a receiving channel thereof; and a receiving channel information transmission operation in which the new node transmits information on the selected receiving channel thereof to a neighboring node.

Nodes, forming the wireless ad-hoc network, may only receive data through receiving channels thereof.

The nodes, forming the wireless ad-hoc network, may switch to a receiving channel of a destination node, being a destination of data, in order to transmit the data, and transmit the data.

The channel scanning operation may include: transmitting, by the new node, beacon requests through all of available channels at a predetermined time interval according to an active scan method; transmitting, by a coordinator having received the beacon request, beacons through all of the available channels at a predetermined time interval; and selecting, by the new node, a receiving channel thereof by using channel information on a neighboring node, acquired from the beacon received from the coordinator.

The selecting of the receiving channel may include selecting a channel with the highest quality as a receiving channel thereof among a plurality of channels when the new node receives a plurality of beacons through the plurality of channels.

The channel scanning operation may further include: transmitting, by the new node, an association request having information on the receiving channel thereof through a receiving channel of the coordinator; and receiving, by the new node, an association response to the association request from the coordinator through the receiving channel of the new node.

The receiving channel information transmission operation may include: transmitting, by the new node, hello frames, each having the information on the receiving channel thereof, through all of the available channels; and receiving, by the new node, a hello reply from at least one neighboring node having received the hello frame though the receiving channel of the new node.

The asynchronous multi-channel adaptation method may further include a channel switching operation in which the new node acquires neighboring channel information to thereby perform channel switching, after the receiving channel information transmission operation is performed.

The channel switching operation may include: transmitting, by the new node, a channel probe request to a neighboring node in order to request a channel probe frame for performing testing on a channel; and receiving, by the new node, a channel probe response to the channel probe request and a channel probe from the neighboring node in a sequential manner.

The new node may switch the receiving channel thereof by using the neighboring channel information acquired from the channel probe.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating a receiver-based asymmetric channel using method;

FIG. 2 is a flowchart illustrating an asynchronous multi-channel adaptation method according to an exemplary embodiment of the present invention;

FIG. 3 is a detailed flowchart illustrating a channel scanning process;

FIG. 4 is a detailed flowchart illustrating a receiving channel information transmission process; and

FIG. 5 is a detailed flowchart illustrating a channel switching process.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

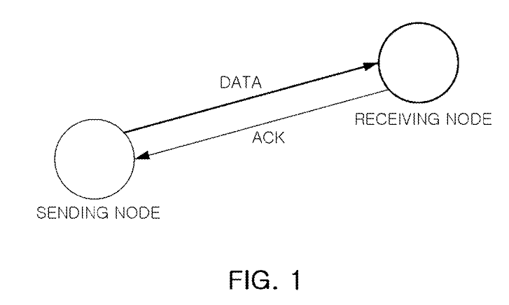

FIG. 1 is a view illustrating a receiver-based asymmetric channel using method.

According to an exemplary embodiment of the invention, nodes that form a wireless ad-hoc network have receiving channels thereof in order to receive data. All of the nodes only receive data through their receiving channels.

Furthermore, in order that each of the nodes transmits data, the node switches to a receiving channel of a destination node, which is a destination of the data.

Here, under symmetrical channel conditions, an ACK frame can be received through that same channel, that is, a receiving channel of a receiving node. Otherwise, an ACK frame is received by switching to a receiving channel of a sending node.

In order to perform data communication using a method of receiving data through a receiving channel of a receiving node, a receiving channel is selected, receiving channel information is transmitted to neighboring nodes, and channel switching is performed as the need arises, by undergoing an asynchronous multi-channel adaptation process to be described below.

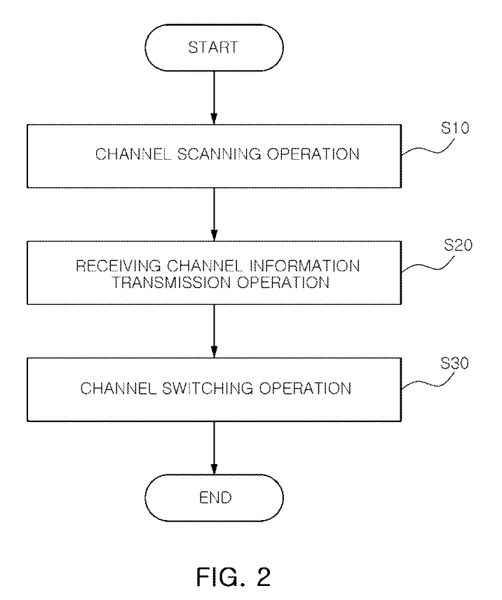

FIG. 2 is a flowchart illustrating an asynchronous multi-channel adaptation method according to an exemplary embodiment of the invention.

As shown in FIG. 2, according to an asynchronous multi-channel adaptation method in this embodiment, a new node scans channels in order to participate in a wireless ad-hoc network, and selects a receiving channel thereof in a channel scanning operation S10, the new node transmits information on the receiving channel thereof to neighboring nodes in a receiving channel information transmission operation S20, and channel switching is performed in a channel switching operation S30. Here, the channel switching operation S30 is selectively performed as the need arises.

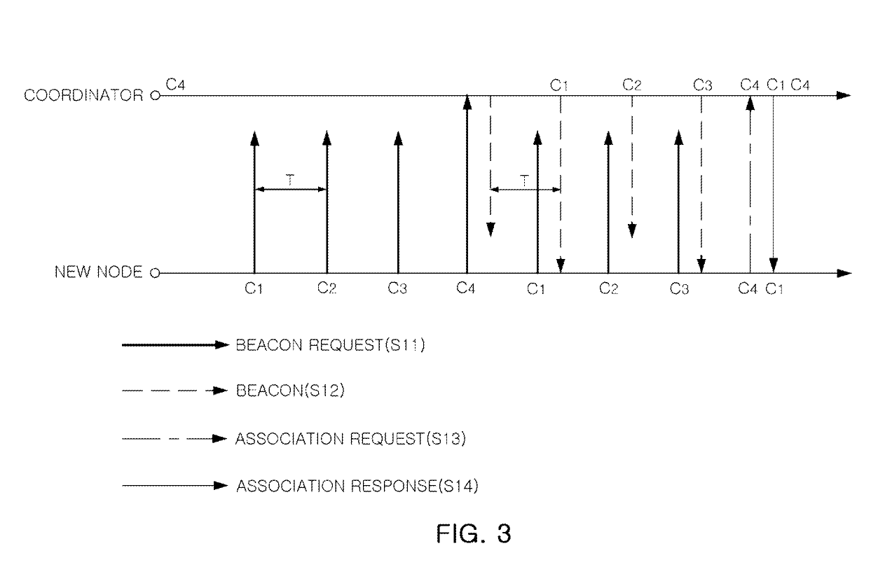

Hereinafter, the respective operations, included in the asynchronous multi-channel adaptation method, will be described in more detail with reference to FIGS. 3 through 5.

FIG. 3 is a detailed flowchart illustrating a channel scanning operation. As shown in FIG. 3, a new node scans channels in order to participate in a wireless ad-hoc network and selects a receiving channel thereof.

In FIG. 3, it is assumed that there are 4 available channels C1 through C4 and that available channels are scanned two times. However, the number of available channels and the number of times that available channels are scanned are not limited thereto.

First, a new node transmits a beacon request through all of the available channels at a predetermined time interval T according to an active scan method in operation S11.

A coordinator, which is a neighboring node having received the beacon request, transmits beacons through all of the available channels at a predetermined time interval T in operation S12. Here, the coordinator refers to a node having a routing function and a network participation function in the wireless ad-hoc network.

Therefore, the new node acquires channel information regarding the neighboring node by using the beacon frame received from the coordinator, so that the new node can select a receiving channel thereof. Here, in the case that the new node receives a plurality of beacon frames through a plurality of channels, the new node uses channel information acquired from the received beacon frames to thereby select a channel with better quality. For example, as shown in FIG. 2, the new node may select one channel C1 between the two channels C1 and C3, through which the new node receives beacon frames, as a receiving channel thereof.

Then, the new node transmits an association request through a receiving channel C4 of the coordinator in operation S13. An association request message includes information on the receiving channel selected by the new node.

Then, the coordinator, having received the association request from the new node, transmits an association request through the receiving channel C1 of the new node in operation S14.

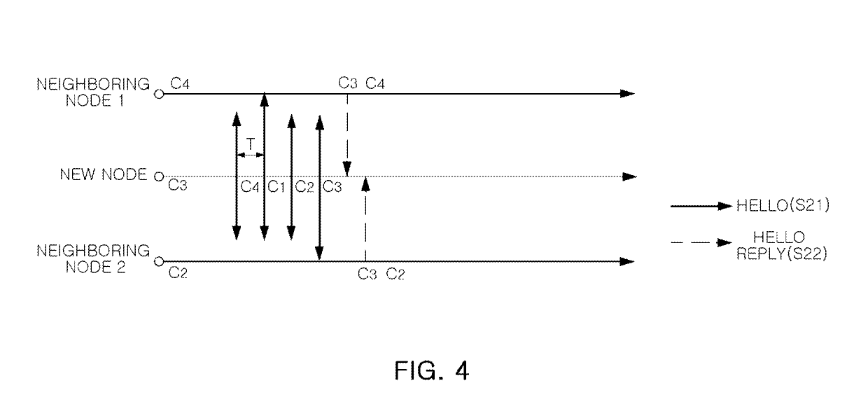

FIG. 4 is a detailed flowchart illustrating a process of transmitting receiving channel information. As shown in FIG. 4, when a new node, which participates in a wireless ad-hoc network, determines a receiving channel thereof, the new node transmits information on the receiving channel to neighboring nodes.

The new node, having selected the receiving channel thereof through the process, illustrated in FIG. 3, carries the information on the receiving channel thereof into a hello frame and transmits the hello frame to at least one neighboring node located adjacently thereto in operation S21. Here, it is assumed that the new node selects the channel C3 as a receiving channel thereof.

Therefore, neighboring nodes 1 and 2, each having received the hello frame from the new node, acquire the receiving channel information of the new node from the hello frame. Data transmission can be performed through the receiving channel of the new node. Furthermore, the neighboring nodes 1 and 2 each transmit a hello reply to the received hello frame through the channel C3, which is the receiving channel of the new node, in operation S22.

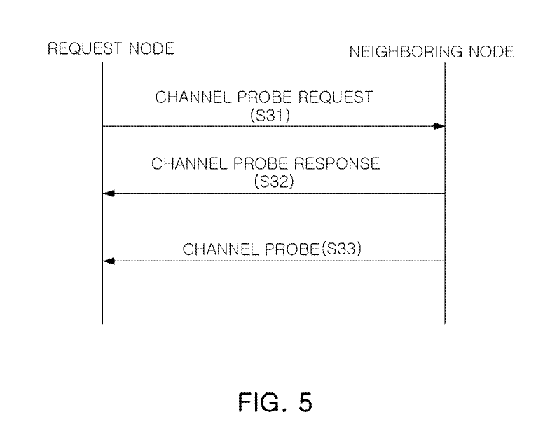

FIG. 5 is a detailed flowchart illustrating a channel switching process. In FIG. 5, when channel switching is required, an arbitrary request node requests that a neighboring node transmit a channel probe frame to thereby acquire neighboring channel information and perform channel switching.

In the wireless ad-hoc network, in order that the arbitrary request node checks as to whether a particular channel is no longer effective during operations or acquires information on a new channel, the arbitrary request node may transmit a channel probe request to a neighboring node for a channel probe frame in order to perform testing on a channel in operation S31.

Therefore, first, the neighboring node, having received the channel probe request, transmits a channel probe reply to the channel probe request in operation S32, and transmits a channel probe to the request node in order to provide channel information in operation S33.

Accordingly, the request node acquires neighboring channel information from the received channel probe and selects a new channel as a receiving channel thereof by using the acquired neighboring channel information.

As set forth above, according to exemplary embodiments of the invention, in order to improve the reliability of data transmission and network scalability in a wireless ad-hoc network, a simple asynchronous adaptation method incurring a low control overhead is proposed.

By using the asynchronous multi-channel adaptation method, interference with a wireless channel can be reduced and stability thereof can be achieved. Furthermore, spatial reuse can be achieved and the resources of the entire network can be saved.

In particular, when a wireless ad-hoc network is provided in large scale, a channel environment may be spatially or temporally unstable. According to an exemplary embodiment of the invention, available multi-channels are asynchronously used to thereby simplify a process and reduce network load.

Furthermore, by taking into account the characteristics of an actual wireless environment as much as possible on the assumption that link channels between all nodes, forming a wireless ad-hoc network, are asymmetrical, an asynchronous multi-channel adaptation method having excellence and utilization can be provided.

While the present invention has been shown and described in connection with the exemplary embodiments, it will be apparent to those skilled in the art that modifications and variations can be made without departing from the spirit and scope of the invention as defined by the appended claims.

What is claimed is:

1. An asynchronous multi-channel adaptation method comprising:
a channel scanning operation in which a new node, participating in a wireless ad-hoc network, scans channels and selects a receiving channel thereof; and
a receiving channel information transmission operation in which the new node transmits information on the selected receiving channel thereof to a neighboring node.

2. The asynchronous multi-channel adaptation method of claim 1, wherein nodes, forming the wireless ad-hoc network, only receive data through receiving channels thereof.

3. The asynchronous multi-channel adaptation method of claim 2, wherein the nodes, forming the wireless ad-hoc network, switch to a receiving channel of a destination node, being a destination of data, in order to transmit the data, and transmit the data.

4. The asynchronous multi-channel adaptation method of claim 1, wherein the channel scanning operation comprises:
transmitting, by the new node, beacon requests through all of available channels at a predetermined time interval according to an active scan method;
transmitting, by a coordinator having received the beacon request, beacons through all of the available channels at a predetermined time interval; and
selecting, by the new node, a receiving channel thereof by using channel information on a neighboring node, acquired from the beacon received from the coordinator.

5. The asynchronous multi-channel adaptation method of claim 4, wherein the selecting of the receiving channel comprises selecting a channel with the highest quality as a receiving channel thereof among a plurality of channels when the new node receives a plurality of beacons through the plurality of channels.

6. The asynchronous multi-channel adaptation method of claim 4, wherein the channel scanning operation further comprises:
transmitting, by the new node, an association request having information on the receiving channel thereof through a receiving channel of the coordinator; and
receiving, by the new node, an association response to the association request from the coordinator through the receiving channel of the new node.

7. The asynchronous multi-channel adaptation method of claim 1, wherein the receiving channel information transmission operation comprises:
transmitting, by the new node, hello frames, each having the information on the receiving channel thereof, through all of the available channels; and
receiving, by the new node, a hello reply from at least one neighboring node having received the hello frame though the receiving channel of the new node.

8. The asynchronous multi-channel adaptation method of claim 1, further comprising a channel switching operation in which the new node acquires neighboring channel information to thereby perform channel switching, after the receiving channel information transmission operation is performed.

9. The asynchronous multi-channel adaptation method of claim 8, wherein the channel switching operation comprises:
transmitting, by the new node, a channel probe request to a neighboring node in order to request a channel probe frame for performing testing on a channel; and
receiving, by the new node, a channel probe response to the channel probe request and a channel probe from the neighboring node in a sequential manner.

10. The asynchronous multi-channel adaptation method of claim 9, wherein the new node switches the receiving channel thereof by using the neighboring channel information acquired from the channel probe.
